(19) United States
(12) Patent Application Publication
(10) Pub. No.: US 2012/0159040 A1
(43) Pub. Date: Jun. 21, 2012

(54) Auxiliary Interface for Non-Volatile Memory System

(76) Inventors: Dhaval Parikh, Sunnyvale, CA (US); Talal Ahwal, Santa Cruz, CA (US)

(21) Appl. No.: 12/969,167

(22) Filed: Dec. 15, 2010

(51) Int. Cl. G06F 12/00

(52) U.S. Cl. 711/103; 711/E12.008

(57) ABSTRACT

A non-volatile memory system is formed a plurality of memory banks and a controller, where the controller has an auxiliary memory interface for use with an additionally non-volatile memory bank, where the additional memory bank and interface are used for metadata, such as logical to physical translation data. The other banks are used for user data. In an exemplary embodiment, a non-volatile memory could include a controller and (N+1) NAND flash memories, where N of these memories would store user data, but the remaining memory with its own controller interface would be dedicated to the storage of metadata. This allows for the metadata to be kept in non-volatile memory, but still quite readily accessible relative to the typical paging/overlay arrangement for metadata that is typically used in many non-volatile memory system.

### FIELD OF THE INVENTION

This invention pertains generally to the field of architectures for non-volatile memory systems and, more particularly, to the arrangement of interfaces between the system controller and its memory arrays.

### BACKGROUND

Non-volatile memory systems for the storage of user data, such flash memory cards, typically are made up of a set of arrays of non-volatile memory cells, on which the user data is stored, and a controller that controls the transfer of the user data between the arrays and a host and also manages the storage of the user data on the system. Much of this system management data, or meta-data, needs also to be retained and is therefore also stored in the non-volatile arrays. An example of such meta-data is the logical to physical translation information by which the physical location of data on an array is associated with the logical address by which the host identifies the data. Other examples can include meta-block linking data and defect re-mapping data.

Historically, flash memory controller manufacturers have used static logical to physical mapping algorithms to map user data in non-volatile memory cells. These translation tables were relatively small (on the order of 64 KB for 128 GB storage capacity) and of fixed size, allowing them easily to be cached on the memory controller. This caching results in good system performance, but has an inherent issue with these static mapping algorithms is their high write amplification ratio. For older generations of flash memory types, such high write amplification ratio was acceptable for a given usage model, since the raw endurance of memory cells was of the order of 50K or more program-erase cycles. However, as the geometry of flash memory chips has continued to shrink, the raw reliability of memory cells is often reduced significantly. Because of this, many flash memory controller manufacturers have adopted dynamic mapping algorithms which provide fairly low write amplification ratios, thereby extending the life of the storage product; however, an inherent issue with these dynamic mapping algorithms is that the translation tables, used to map logical to physical addresses, can be very large, growing, for example, to the order of 500 MB. To optimize performance, the controller would preferably cache the entire translation table in the internal memory of the controller; however, it is extremely expensive to have such large pool of SRAM memory in the controller. Consequently, there is room for improvement in the handling of large and complicated metadata in such memory systems.

### SUMMARY OF THE INVENTION

According to a general aspect of the invention, a memory system includes multiple banks of non-volatile memory cells and a controller to manage the transfer of user data between a host and the memory system and also to manage the storage of user data from the host in the memory banks. The controller circuit includes a host interface, by which user data is transferred between the host and the controller circuit, an internal bus connected to the host interface, and multiple memory bank interfaces connected to the internal bus, whereby user data and management data is respectively transferred between the controller circuitry and a corresponding one of the memory banks. The controller circuitry also includes a volatile memory connected to the internal bus, in which the controller stores management data for use in managing the storage of user data, and processing circuitry connected to the internal bus, where the processing circuitry dedicates one of the memory banks for the storage of management data and stores user data on the other N memory banks.

Various aspects, advantages, features and embodiments of the present invention are included in the following description of exemplary examples thereof, whose description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 illustrates a non-volatile memory system using a DRAM memory block and corresponding interface for the storage of metadata.

FIG. 2 is a non-volatile memory arrangement to show an overlay/paging scheme approach for metadata.

FIG. 3 is a block diagram of an exemplary embodiment of a memory system with an auxiliary flash interface and corresponding memory

### DETAILED DESCRIPTION

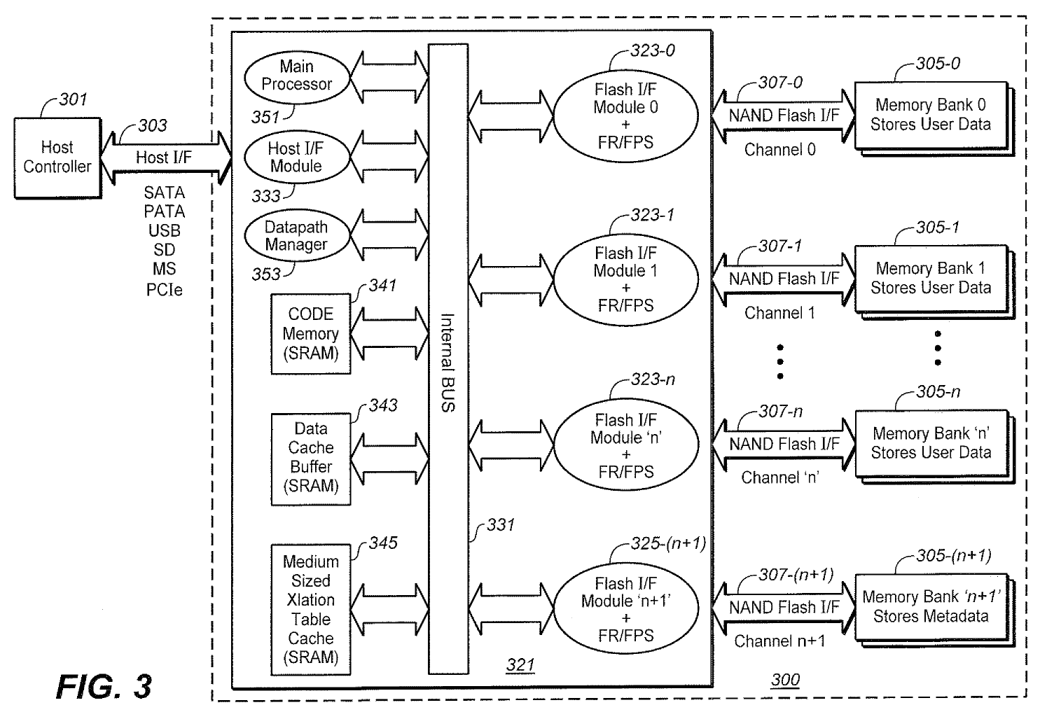

The techniques presented here can provide a cost effective non-volatile memory system that also provides high performance. This is done by providing the controller with an auxiliary memory interface for use with an additionally non-volatile memory bank, where the additional memory bank and interface are used for metadata, such as logical to physical translation data, with the user data being kept on the other memory banks. To give a specific example, a non-volatile memory could include a controller and (N+1) NAND flash memories, where N of these memories would store user data, but the remaining memory with its own controller interface would be dedicated to the storage of metadata. This allows for the metadata to be kept in non-volatile memory, but still quite readily accessible relative to the typical paging/overlay arrangement for metadata that is typically used in many non-volatile memory system. Before describing an exemplary embodiment, discussed below with respect to FIG. 3, several alternate embodiments of non-volatile memory system will be considered.

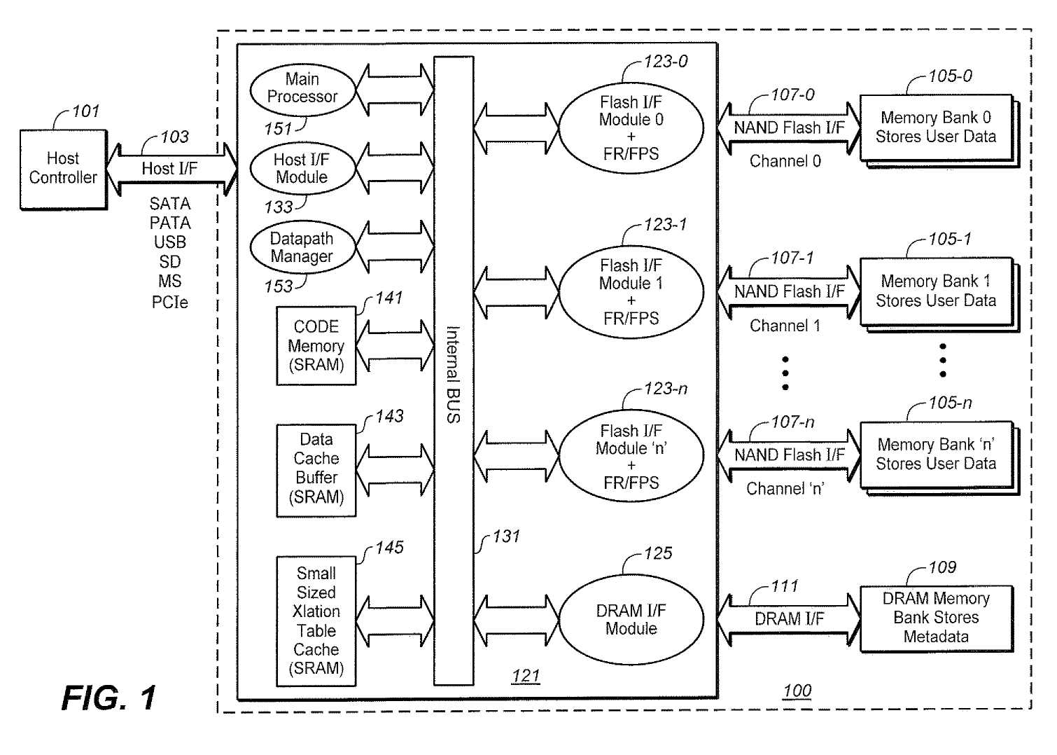

One approach is to store the translation tables and other control data structures (or “meta-data”) in the same memory banks as user data and then load it when the device is run into a DRAM memory that is external to the controller. This is illustrated in FIG. 1. As shown there, a memory device 100 is connected to a host 101 through the physical host interface 103. The memory system is typically a detachable device, such as a memory card, but could also be an embedded device, and the interface is typically a physical connection, but could also be a wireless interface. A few examples for the host interface are SATA (Serial ATA), DATA (Parallel ATA), USB, Secure Digital (SD) and micro-SD (μSD), Memory Stick (MS), PCIe (PCI Express), and so on. Memory system 100 includes controller 121 and (n+1) non-volatile memory banks 105-0, . . . , 105-n, where n is a non-negative integer, each connected through a corresponding physical interface 107-0, . . . , 107-n, here for the example of a NAND flash device. Each of the memory banks may consist of multiple arrays or chips, as indicated by the stacked rectangles. Each of the memory banks 0-n are usually of the same design, where some examples of non-volatile memories chips are described, for example, in U.S. Pat. Nos. 5,570,315, 5,903,495, 6,046,935 and U.S. patent applications Ser. No. 12/833,167 filed on Jul. 9, 2010, and Ser. No. 12/635,449 filed on Dec. 10, 2009.

Controller 121 is a block diagram of an exemplary controller with some of the relevant elements shown. The controller communicates with the host by way of host interface module 133 and the non-volatile memory banks through the corresponding memory interface module 123-0, . . . , 123-n. including a Flash Control RISC Processor (FR) and a Flash Protocol Sequencer (FPS). These interfaces are then connected along the controller's internal bus structure 131. The controller also has processing circuitry, with an exemplary embodiment including a main processor 151 and a data path manager 153, which is an independent processor integrated in the same controller. The data path manager manages the flow of data once it enters the controller through host interface, directing DMA (Direct Memory Access) engines to transfer data between the various internal memories and managing data overflows and data under-runs. There could be one or more instances of such processors, each dedicated to manage transfer of data between different controller memory modules. The controller usually will also have some amount of volatile SRAM memory to use for various purposes, here including a portion for storing code 141 it uses to operate, a data cache buffer portion 143 where the controller can buffer data begin transferred between the host 101 and the non-volatile memory banks 105-0, . . . , 105-n, and a portion 145 for caching management data or metadata, such as logical to physical address translation tables. The multiple instances of SRAM memory blocks in the controller core optimized for performance, power consumption and to better manage real estate (layout) of the controller core logic, although, for the purposes of this discussion, the SRAM memory can be considered as one logical entity. To address some of the problems described in the Background, the memory system of FIG. 1 also includes an additional, relatively fast volatile memory, here DRAM memory bank 109, connected though the physical DRAM interface 111 to the controller 121, where it then connects to the internal bus 131 by way of the DRAM interface module 125.

Under the arrangement of FIG. 1, user (or host) data is stored into the non-volatile memory banks 105-0, . . . , 105-n. Metadata, such as the translation tables and other control data structures, is stored in the same memory banks as user data and then loaded when the system is run into the DRAM bank 109 which is external to the controller 121. When running, the user controller transfers the data between the host and the non-volatile banks, while the DRAM channel is dedicated to the metadata. Because of this dedicated metadata channel, and the speed of the DRAM, a relatively small metadata cache 145 can be used, saving on the amount of relatively expensive SRAM memory on the controller. The meta-data are mostly arrays of data-structures stored in the DRAM or SRAM and their updates are easily managed in their respective memories (SRAM or DRAM). Periodically, these updated translation tables and other data-structures are written back to non-volatile Flash memory in order to prevent losing them in case of unexpected system power loss.

The arrangement of FIG. 1 can provide fast system performance, but has some drawbacks. One is the high relative component cost associated with including a DRAM memory. Another is that what is primarily a non-volatile memory controller 121, typically a NAND flash memory controller, would need a dedicated DRAM interface 111 and module 125 separate form the NAND interfaces to store and retrieve the metadata from DRAM bank 109. Also, if power is lost for the memory system or operation is otherwise interrupted, any metadata that is held only in the DRAM bank 109 and metadata cache 145, such as updated logical-physical translation data, would be lost. Consequently, the various costs associated with the arrangement of may be justified for performance intensive applications, such as solid state storage devices (SSD) or higher end embedded memory applications, but is not optimal for applications such as typical memory cards.

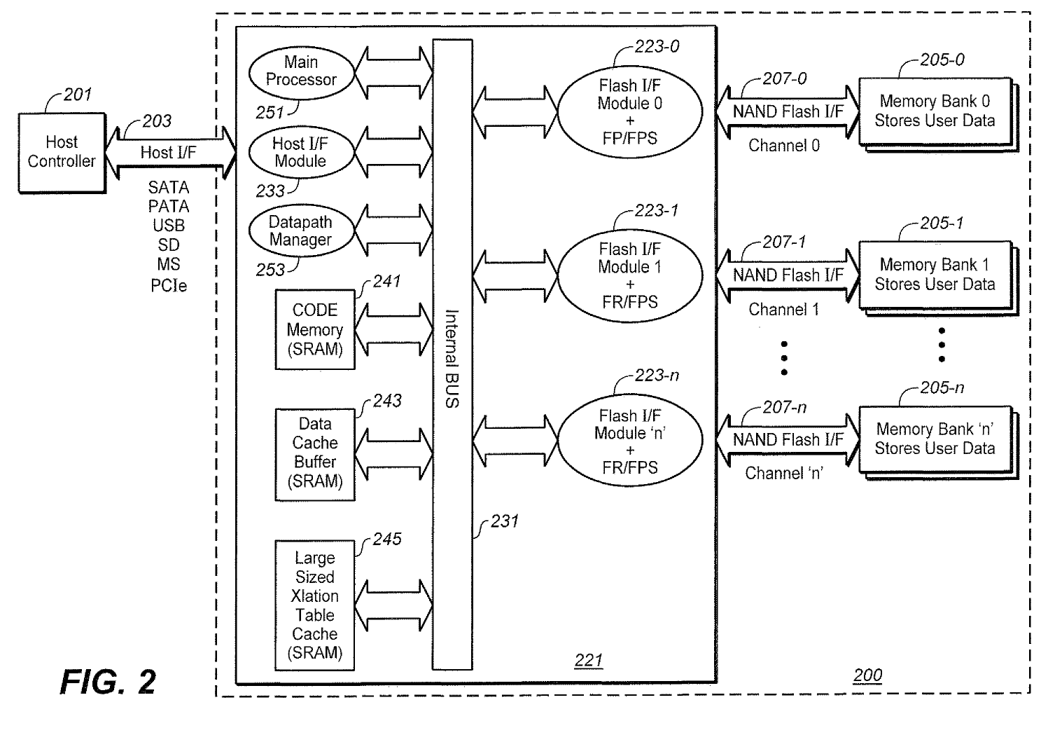

An alternative arrangement, that can be used for storage applications that do not require high system performance, is illustrated with respect to FIG. 2. (Such an arrangement is common in many flash memory card applications.) The elements of FIG. 2 are largely the same as in FIG. 1, and are similarly numbered, except the DRAM related elements are omitted. Under this arrangement, the metadata is stored on the same memory banks as the user data (105-0, . . . , 105-n). Needed meta-data is then transferred to the metadata cache 245 as needed using an overlay or paging arrangement. Although this has the advantage, relative to FIG. 1, of lower system cost and of not needing a DRAM interface, it does provide poorer system performance.

FIG. 3 illustrates an exemplary embodiment that can provide a cost-effective solution to store and retrieve the often complicated management metadata or control structure without comprising system performance or throughput. In addition to the set of flash memory banks used to store user data, an additional flash memory bank is added and dedicated for the storage of metadata. This auxiliary flash channel is used as an out-of-band storage interface to store and retrieve metadata associated flash management algorithms used to manage user-data. This out-of-band or auxiliary interface can also be used to consume some part of the user-data which may preferably be treated specially. Some examples of such critical data could be OS (Operating System) data, or system log data which have high reliability requirement.

As shown in FIG. 3, a memory device 300 is again connected to a host 301 through the physical host interface 303. The memory system 300 includes controller 321 and (n+1) non-volatile memory banks 305-0, . . . , 305-n, where n is a non-negative integer, each connected through a corresponding physical interface 307-0, . . . , 307-n, here for the example of a NAND flash device. Each of the memory banks 0-n are usually of the same design, where some examples of non-volatile memories chips are described in for example, in U.S. Pat. Nos. 5,570,315, 5,903,495, 6,046,935 and U.S. patent applications Ser. No. 12/833,167 filed on Jul. 9, 2010, and Ser. No. 12/635,449 filed on Dec. 10, 2009. The controller circuitry 321 communicates with the host 301 by way of host interface module 333 and the non-volatile memory banks through the corresponding memory interface module 323-0, . . . , 323-n, which are in turn connected along the controller's internal bus structure 331. The controller's processing circuitry includes a main processor 151 and a data path manager 153 and the volatile SRAM memory includes a portion for storing code 141 it uses to operate, a data cache buffer portion 143, and a portion 145 for caching management data or metadata. More detail on controllers is presented in U.S. Patent Application Publication Number: US-2006-0140007-A1 on Jun. 29, 2006, for example, and references cited therein.

The exemplary embodiment of FIG. 3 adds an additional bank 305-(n+1) of flash memory, an auxiliary memory interface 311-(n+1) to connect it to the controller 321, and, in the controller, a corresponding interface module 323-(n+1). These elements then form an out-of-band storage interface for address translation data and other meta data. The non-volatile memory bank 305-(n+1) can then store some or all of the metadata that previously needed to be stored in the user data banks 305-0, . . . , 305-n and which, at start up, would previously had to have been transferred over to the DRAM bank 109 under the arrangement of FIG. 1. Consequently, in case of power loss or other improper shutdown, only the most recent updates, that were only held in the control data cache 345 and not yet written back to bank 305-(n+1), would be lost. Also, since the meta data has its own channel, the size of control data cache 345 need only be medium sized, where “medium sized” is implementation specific, saving on the amount of expensive SRAM needed by the controller relative to that (245, FIG. 2) of the paging/overlay arrangement.

Relative to the DRAM approach of FIG. 1, the embodiment of FIG. 3 is cost effective and the cost per gigabyte of storage on a NAND flash memory chip is much lower, resulting in a significantly lower cost compared to the DRAM based solution. Relative to the paging/overlay arrangement of FIG. 2, an embodiment such as presented in FIG. 3 provides higher performance. This combination of relatively low cost and relatively high performance makes the use of such an auxiliary non-volatile memory interface suitable for a broad variety of memory system applications, both detachable memory card-type solutions, as well as solid state drives (SSDs) and embedded systems, such as would be found on netbooks, notebooks, set-top boxes, printers, Tablets, SmartBooks, mobile internet devices (MIDs), and so on.

In the exemplary embodiment, the memory banks are all taken be of the same type, but with one dedicated to metadata. The device used for metadata can be pre-selected, or determined by the controller when the system is first used, and in the most basic arrangement will be kept fixed, although it could also be rotated for wear leveling or data consolidation reasons. As system data often tends to be rewritten more frequently than user data, this could lead to more frequent writes on the dedicated metadata bank; but as these writes are often relatively small (as opposed the large writes of logically contiguous data write common in user data), and bank capacity can be quite large, this should not result in the lifetime of the metadata bank being a limiting factor for the system. If there are such lifetime concerns for the metadata bank, the controller could manage it differently than the user data banks based on the different data types (small, non-contiguous writes as opposed to large, logically contiguous writes) or even operate the metadata bank in a binary format, while using multi-state (MLC) storage for user data. (More detail on memory systems using both binary and MLC storage is found in U.S. patent application Ser. No. 12/640,820 filed on Dec. 17, 2009, and U.S. patent applications Ser. No. 12/642,584, 12/642,740, 12/642,611 and 12/642,649, all filed on Dec. 18, 2009.) In other embodiments, the dedicated bank could, for example, be a Flash memory having a NOR architecture, allows the data to be accessed on a cell by cell basis, while the other banks use a NAND architecture.

Even though the arrangement of FIG. 3 shown one bank (305-(n+1)) dedicated to metadata, with the other for user data, some metadata may also be stored on the user data banks. This could be the case for metadata that is specific to a particular set of data or to a particular physical location, such as defect re-mapping, the number of program/erase cycle count associated with a given erase block, or indications of write or erase completion. FIG. 3 can also be generalized by including additional metadata blocks/channels, which could then all be used in the same manner, or differentially employed with some types of metadata using one such auxiliary channel and other types using another auxiliary channel.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

It is claimed:

1. A memory system comprising:
N+1 memory banks of non-volatile memory cells, where N is a non-negative integer; and
a controller circuit to manage the transfer of user data between a host and the memory system and to manage the storage of user data from the host in the memory banks, the controller circuit including:
a host interface whereby user data is transferred between the host and the controller circuit;
an internal bus connected to the host interface;
N+1 memory bank interfaces connected to the internal bus whereby user data and memory management data is respectively transferred between the controller circuit and a corresponding one of the N+1 memory banks;
a volatile memory connected to the internal bus, wherein the controller circuit stores memory management data for use in managing the storage of user data;
processing circuitry connected to the internal bus, where the processing circuitry dedicates a first one of said memory banks for the storage of memory management data and stores user data on the other N memory banks.

2. The memory system of claim 1, wherein the memory management data includes logical to physical translation data.

3. The memory system of claim 1, wherein the memory management data includes defect re-mapping data.

4. The memory system of claim 1, wherein the memory management data includes meta-block linking data.

5. The memory system of claim 1, wherein the memory management data includes error correction data.

6. The memory system of claim 1, wherein the processing circuitry further stores user data requiring higher reliability in the first memory bank.

7. The memory system of claim 6, wherein the user data requiring higher reliability includes operating system data.

8. The memory system of claim 6, wherein the user data requiring higher reliability includes system log data.

9. The memory system of claim 1, wherein the controller circuit and each of the memory banks are formed on separate chips.

10. The memory system of claim 9, wherein all of the memory bank chips are formed the same.

11. The memory system of claim 9, wherein the first of the memory banks is a flash memory having a NOR architecture and the other N memory banks are flash memories of a NAND architecture.

12. The memory system of claim 9, wherein the first of the memory banks stores data in a binary format and the other N memory banks store data in a multi-state format.

13. The memory system of claim 1, wherein the processing circuitry includes a main processor and a data path manager.

14. The memory system of claim 1, wherein the controller further caches user data in the volatile memory.

15. The memory system of claim 1, wherein the controller further stores code in the volatile memory.

16. A controller formed on an integrated circuit for use with a plurality of N+1 memory banks of non-volatile memory cells, where N is a non-negative integer, to manage the transfer of user data between a host and the memory banks and to manage the storage of user data from the host in the memory banks, the controller comprising:
a host interface whereby user data is transferred between the host and the controller circuit;
an internal bus connected to the host interface;
N+1 memory bank interfaces connected to the internal bus whereby user data and memory management data is respectively transferred between the controller circuit and a corresponding one of the N+1 memory banks;
a volatile memory connected to the internal bus, wherein the controller circuit stores memory management data for use in managing the storage of user data;
processing circuitry connected to the internal bus, where the processing circuitry dedicates a first one of said memory banks for the storage of memory management data and stores user data on the other N memory banks.

17. The controller of claim 16, wherein the memory management data includes logical to physical translation data.

18. The controller of claim 16, wherein the memory management data includes defect re-mapping data.

19. The controller of claim 16, wherein the memory management data includes meta-block linking data.

20. The controller of claim 16, wherein the memory management data includes error correction data.

21. The controller of claim 16, wherein the processing circuitry further stores user data requiring higher reliability in the first memory bank.

22. The controller of claim 21, wherein the user data requiring higher reliability includes operating system data.

23. The controller of claim 21, wherein the user data requiring higher reliability includes system log data.

24. The controller of claim 16, wherein the processing circuitry includes a main processor and a data path manager.

25. The controller of claim 16, wherein the controller further caches user data in the volatile memory.

26. The controller of claim 16, wherein the controller further stores code in the volatile memory.
